(19) United States
(12) Patent Application Publication
(10) Pub. No.: US 2017/0294016 A1
(43) Pub. Date: Oct. 12, 2017

(54) APPARATUS AND METHOD OF PROCESSING COMPUTED TOMOGRAPHY IMAGE

(71) Applicant: SAMSUNG ELECTRONICS CO., LTD., Suwon-si (KR)

(72) Inventors: Yeon-ju LEE, Suwon-si (KR); Dong-oan RO, Suwon-si (KR); Yeong-ae YU, Yongin-si (KR)

(73) Assignee: SAMSUNG ELECTRONICS CO., LTD., Suwon-si (KR)

(21) Appl. No.: 15/485,331

(22) Filed: Apr. 12, 2017

(30) Foreign Application Priority Data
Apr. 12, 2016 (KR) 10-2016-0044941
Mar. 20, 2017 (KR) 10-2017-0034923

(51) Int. Cl. G06T 7/00

(52) U.S. Cl. CPC G06T 7/0012; G06T 2207/10081

(57) ABSTRACT

An apparatus for processing a computed tomography (CT) image includes a processor configured to set window widths and window levels of a plurality of setting areas, and a display configured to display a screen view showing a plurality of CT images on the plurality of setting areas, wherein the plurality of setting areas have different window levels. The window widths are portions of a display range of the display, and the window lengths are midpoints of the portions of the display range of the display. The processor generates and converts the CT images according to the window widths and the window levels.

### CROSS-REFERENCE TO RELATED APPLICATIONS

This application claims the benefit of Korean Patent Application Nos. 10-2016-0044941, filed on Apr. 12, 2016 and 10-2017-0034923, filed on Mar. 20, 2017, in the Korean Intellectual Property Office, the disclosures of which are incorporated herein in their entirety by reference.

### BACKGROUND

### 1. Field

The present disclosure relates to apparatuses for processing computed tomography (CT) images, methods of processing CT images, and computer program products including non-transitory computer-readable recording media that includes instructions for executing the methods.

### 2. Description of the Related Art

Computed tomography (CT) images may be represented by CT numbers. CT numbers may include Hounsfield units (HU's) and values for describing radiolucency. CT numbers may be integers ranging from about −1024 to 3071 and may be represented as 12-bit image data. CT images are often black-and-white images using CT numbers or images with limited color components. Accordingly, for accurate diagnosis, images have to be displayed in a wide grayscale range. However, since the number of gray levels that may be displayed on a display may be less than the number of CT numbers of CT image data, the display may not be able to display the full range of CT image data in some cases.

### SUMMARY

Exemplary embodiments are provided to simultaneously check two or more parts of an object with different computed tomography (CT) number ranges when a CT image is displayed.

Also, embodiments are provided to easily adjust a window width and a window level while a slice section is changed when a CT image is displayed.

Additional aspects will be set forth in part in the description which follows and, in part, will be apparent from the description, or may be learned by practice of the disclosed exemplary embodiments.

According to an aspect of an embodiment, an apparatus for processing a computed tomography (CT) image includes: a display configured to display a screen view showing a plurality of CT images wherein each CT image of the plurality of the CT images comprises a setting area; and a processor configured to set window widths that indicate a number of CT numbers included in a CT number range that may change a display grayscale and window levels that are representative values of the CT numbers included in the CT number range, of the plurality of setting areas of the display and generate ad convert the plurality of CT images according to the window widths and the window levels respectively corresponding to each setting area, wherein each setting area has different window levels.

Each of the plurality of setting areas may correspond to a viewing area of the display.

The apparatus may further include an input device configured to receive a control signal for controlling the screen view, wherein the processor is further configured to change at least one from among a rendering method, a zooming setting value, and slice sections, for the plurality of setting areas, based on the control signal.

The plurality of setting areas may correspond to different areas on the display defined in one CT image.

The apparatus may further include an input device configured to receive a control signal for setting the plurality of setting areas, wherein the processor is further configured to perform at least one from among a process of adding a setting area, a process of deleting the setting area, a process of changing the setting area, a process of changing a window width of the setting area, and a process of changing a window level of the setting area, based on the control signal.

The apparatus may further include a storage configured to store information about the setting area, the window width, and the window level set according to the control signal.

The apparatus may further include an input device configured to receive a control signal for setting the plurality of setting areas, wherein the processor is further configured to generate, on the screen view, another setting area displaying CT image data that is same as CT image data displayed on a setting area selected by the control signal, from among the plurality of setting areas.

Window widths and window levels of the plurality of setting areas may be differently defined according to slice sections of the CT image.

Positions and sizes of the plurality of setting areas may be differently defined according to slice sections of CT image data.

At least one from among positions, sizes, window widths, and window levels of the plurality of setting areas may be differently defined according to segments of an object displayed on CT image data.

According to an aspect of another embodiment, a method of processing a computed tomography (CT) image includes: setting window widths that indicate a number of CT numbers included in a CT number range that may change a display grayscale and window levels that are representative values of the CT numbers included in the CT number range, for a plurality of setting areas of a display; generating and converting a plurality of CT images according to the window widths and the window levels corresponding to each of the plurality of setting areas; and displaying a screen view showing the plurality of CT images respectively corresponding to each of the plurality of setting areas, wherein each of the plurality of setting areas have different window levels.

According to an aspect of another embodiment, a computer program product includes a non-transitory computer-readable storage medium, the computer-readable storage medium including instructions for: setting window widths that indicate a number of CT numbers included in a CT number range that may change a display grayscale and window levels that are representative values of the CT numbers included in the CT number range, for a plurality of setting areas of a display; generating and converting a plurality of computed tomography (CT) images according to the window widths and the window levels corresponding to the plurality of setting areas; and displaying a screen view showing the plurality of CT images respectively corresponding to the plurality of setting areas, wherein the plurality of setting areas have different window levels, wherein the plurality of CT images correspond to a same slice of a same data set.

### BRIEF DESCRIPTION OF THE DRAWINGS

The preceding and/or other aspects will become apparent and more readily appreciated from the following description of the exemplary embodiments, taken in conjunction with the accompanying drawings in which:

FIG. 1 schematically illustrates a computed tomography (CT) system according to an exemplary embodiment;

FIG. 2 is a block diagram illustrating a structure of the CT system of FIG. 1 according to an exemplary embodiment;

FIG. 3 is a diagram illustrating a configuration of a communication device according to an exemplary embodiment;

FIG. 4 is a block diagram illustrating a structure of an apparatus for processing a CT image according to an exemplary embodiment;

FIG. 5 is a diagram illustrating CT numbers of body tissue, organs, and materials according to an exemplary embodiment;

FIG. 6 is a diagram for explaining a CT number and a display grayscale according to an exemplary embodiment;

FIGS. 7A and 7B illustrate a display image, a transfer graph, and a histogram according to an exemplary embodiment;

FIG. 8 is a diagram illustrating window widths and window levels of two or more setting areas according to an exemplary embodiment;

FIG. 9 is a flowchart of a method of processing a CT image according to an exemplary embodiment;

FIG. 10 illustrates a screen view according to an exemplary embodiment;

FIG. 11 is a view for explaining an operation of adjusting window widths and window levels of viewing areas according to an exemplary embodiment;

FIG. 12 illustrates a screen view showing a CT image displayed on a plurality of setting areas according to an exemplary embodiment;

FIG. 13 illustrates a screen view according to an exemplary embodiment;

FIG. 14 is a block diagram of an apparatus for processing a CT image according to an exemplary embodiment;

FIG. 15 illustrates a state where a setting area is generated according to an exemplary embodiment;

FIG. 16 illustrates a state where a setting area is generated according to an exemplary embodiment;

FIG. 17 is a view illustrating a process of adjusting a plurality of setting areas, a window width, and a window level according to an embodiment;

FIG. 18 is a view for illustrating a process of adjusting a plurality of setting areas, a window width, and a window level;

FIG. 19 illustrates a graphical user interface (GUI) screen view according to an exemplary embodiment; and

FIG. 20 illustrates a GUI screen according to an exemplary embodiment.

### DETAILED DESCRIPTION

Advantages and features of one or more exemplary embodiments of the present disclosure and methods of accomplishing the same may be understood more readily by reference to the following detailed description of the exemplary embodiments and the accompanying drawings. In this regard, the present exemplary embodiments may have different forms and should not be construed as being limited to the descriptions set forth herein. Rather, these exemplary embodiments are provided so that this disclosure will be thorough and complete and will fully convey the concept of the present exemplary embodiments to one of ordinary skill in the art, and the present disclosure will be defined by the appended claims. Like reference numerals refer to like elements throughout the specification.

Hereinafter, the terms used in the specification will be briefly defined, and the exemplary embodiments will be described in detail.

All terms including descriptive or technical terms which are used herein should be construed as having meanings that are familiar to one of ordinary skill in the art. However, the terms may have different meanings according to the intention of one of ordinary skill in the art, precedent cases, or the appearance of new technologies. Also, some terms may be arbitrarily selected by the applicant, and in this case, the meaning of the selected terms will be described in detail in the detailed description of the present disclosure. Thus, the terms used herein should be defined based on the meaning of the terms together with the description throughout the specification.

When a part “includes” or “comprises” an element, unless there is a particular description contrary thereto, the part can further include other elements, not excluding the other elements. Also, the term “unit” in the embodiments of the present disclosure means a software component or hardware component such as a field-programmable gate array (FPGA) or an application-specific integrated circuit (ASIC), and performs a specific function. However, the term “unit” is not limited to software or hardware. The “unit” may be formed so as to be in an addressable storage medium, or may be formed so as to operate one or more processors. Thus, for example, the term “unit” may refer to components such as software components, object-oriented software components, class components, and task components, and may include processes, functions, attributes, procedures, subroutines, segments of program code, drivers, firmware, micro codes, circuits, data, a database, data structures, tables, arrays, or variables. A function provided by the components and “units” may be associated with the smaller number of components and “units”, or may be divided into additional components and “units”.

Reference will now be made in detail to exemplary embodiments, which are illustrated in the accompanying drawings. In this regard, the present embodiments may have different forms and should not be construed as being limited to the descriptions set forth herein. In the following description, well-known functions or constructions are not described in detail so as not to obscure the exemplary embodiments with unnecessary detail.

Throughout the specification, an “image” may mean multi-dimensional data formed of discrete image elements, e.g., pixels in a two-dimensional (2D) image and voxels in a three-dimensional (3D) image. For example, the image may include a medical image of an object which is captured by a computed tomography (CT) imaging apparatus.

Throughout the specification, a “CT image” may mean an image generated by synthesizing a plurality of X-ray images that are obtained by photographing an object while a CT imaging apparatus rotates around at least one axis with respect to the object.

Throughout the specification, an “object” may be a human, an animal, or a portion of a human or animal. For example, the object may be an organ (e.g., the liver, heart, womb, brain, breast, or abdomen), a blood vessel, or a combination thereof. Also, the object may be a phantom. The phantom means a material having a density, an effective atomic number, and a volume that are approximately the same as those of an organism. For example, the phantom may be a spherical phantom having properties similar to the physical body.

Throughout the specification, a “user” may be, but is not limited to, a medical expert including a medical doctor, a nurse, a medical laboratory technologist, a medial image expert, or a technician who repairs a medical apparatus.

Since a CT system is capable of providing a cross-sectional image of an object, the CT system may more distinctively express an inner structure, e.g., an organ such as a kidney or a lung, of the object, as compared to a general X-ray imaging apparatus.

The CT system may obtain a plurality of pieces of image data with a thickness not more than 2 mm at a rate of several tens to several hundred times per second, and then may process the plurality of pieces of image data, so that the CT system may provide a relatively accurate cross-sectional image of the object. According to the related art, only a horizontal cross-sectional image of the object can be obtained, but this issue has been overcome due to various image reconstruction methods. Examples of 3D image reconstruction methods are as below:
Shade surface display (SSD)—an initial 3D imaging method of displaying only voxels having a predetermined Hounsfield Units (HU) value.
Maximum intensity projection (MIP)/minimum intensity projection (MinIP)—a 3D imaging method of displaying only voxels having the greatest or smallest HU value from among voxels that construct an image.
Volume rendering (VR)—an imaging method capable of adjusting a color and transmittance of voxels that constitute an image, according to areas of interest.
Virtual endoscopy—a method that allows endoscopy observation in a 3D image that is reconstructed by using the VR method or the SSD method.
Multi-planar reformation (MPR)—a method of reconstructing an image into a different cross-sectional image. A user may reconstruct an image in any desired direction.
Editing—a method of editing adjacent voxels so as to allow a user to easily observe an area of interest in volume rendering.
Voxel of interest (VOI)—a method of displaying only a selected area in volume rendering.

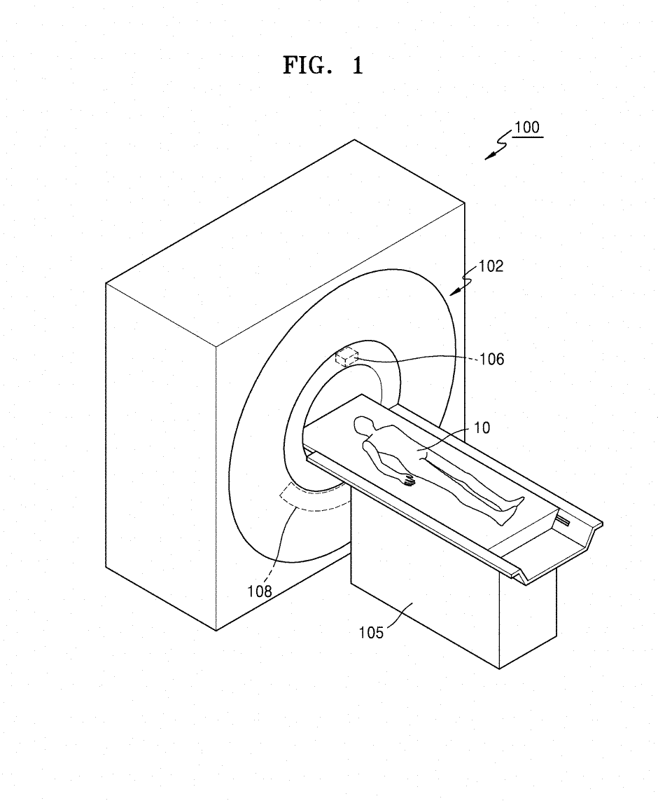

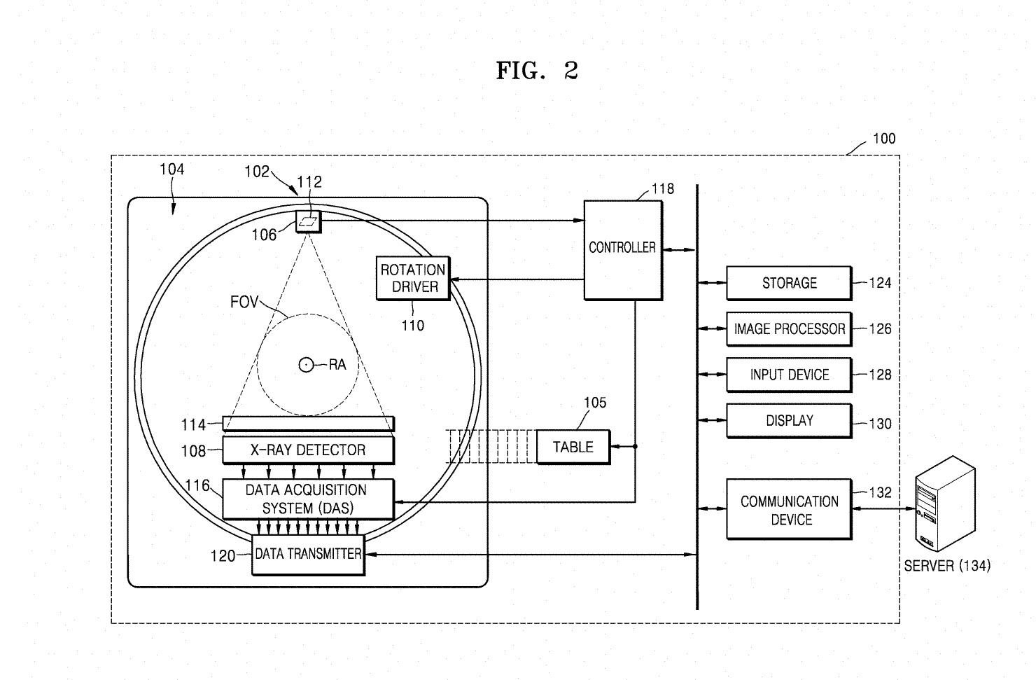

A CT system 100 according to an embodiment will now be described with reference to FIGS. 1 and 2. The CT system 100 may include various types of devices.

FIG. 1 schematically illustrates the CT system 100. Referring to FIG. 1, the CT system 100 may include a gantry 102, a table 105, an X-ray generating unit 106 (which may also be referred to as an “X-ray generator”), and an X-ray detector 108.

The gantry 102 may include the X-ray generating unit 106 and the X-ray detector 108.

An object 10 may be positioned on the table 105.

The table 105 may move in a predetermined direction (e.g., at least one of up, down, right, and left directions) during a CT imaging procedure. Also, the table 105 may tilt or rotate by a predetermined angle in a predetermined direction. The CT system 100 may include at least one motor for moving the table 105 in the predetermined direction, and/or at least one motor for tilting or rotating the table 105.

The gantry 102 may also tilt by a predetermined angle in a predetermined direction. The CT system 100 may include at least one motor for tilting the gantry.

FIG. 2 is a block diagram illustrating a structure of the CT system 100.

The CT system 100 may include the gantry 102, the table 105, a controller 118, a storage 124, an image processor 126, an input device 128, a display 130, and a communication device 132.

As described above, the object 10 may be positioned on the table 105. In the present embodiment, the table 105 may move in a predetermined direction (e.g., at least one of up, down, right, and left directions), and movement of the table 105 may be controlled by the controller 118.

The gantry 102 may include a rotating frame 104, the X-ray generating unit 106, the X-ray detector 108, a rotation driver 110, a data acquisition system (DAS) 116, and a data transmitter 120. The system may include at least one motor for rotating the frame 104.

The gantry 102 may include the rotating frame 104 having a loop shape capable of rotating with respect to a predetermined rotation axis RA. Also, the rotating frame 104 may have a disc shape.

The rotating frame 104 may include the X-ray generating unit 106 and the X-ray detector 108 that are arranged to face each other so as to have predetermined fields of view FOV. The rotating frame 104 may also include an anti-scatter grid 114. The anti-scatter grid 114 may be positioned between the X-ray generating unit 106 and the X-ray detector 108.

In a medical imaging system, X-ray radiation that reaches a detector (or a photosensitive film) includes not only attenuated primary radiation that forms a valuable image but also scattered radiation that deteriorates the quality of an image. In order to transmit most of the primary radiation and to attenuate the scattered radiation, the anti-scatter grid 114 may be positioned between a patient and the detector (or the photosensitive film).

For example, the anti-scatter grid 114 may be formed by alternately stacking lead foil strips and an interspace material such as a solid polymer material, solid polymer, or a fiber composite material. However, formation of the anti-scatter grid 114 is not limited thereto.

The rotating frame 104 may receive a driving signal from the rotation driver 110 and may rotate the X-ray generating unit 106 and the X-ray detector 108 at a predetermined rotation speed. The rotating frame 104 may receive the driving signal and power from the rotation driver 110 while the rotating frame 104 contacts the rotation driver 110 via a slip ring (not shown). Also, the rotating frame 104 may receive the driving signal and power from the rotation driver 110 via wireless communication.

The X-ray generating unit 106 may receive a voltage and current from a power distribution unit (PDU) (not shown) via a slip ring (not shown) and then a high voltage generating unit (not shown), and may generate and emit an X-ray. When the high voltage generating unit applies a predetermined voltage (hereinafter, referred to as a tube voltage) to the X-ray generating unit 106, the X-ray generating unit 106 may generate X-rays having a plurality of energy spectra that correspond to the tube voltage.

The X-ray generated by the X-ray generating unit 106 may be emitted in a predetermined form due to a collimator 112.

The X-ray detector 108 may be positioned to face the X-ray generating unit 106. The X-ray detector 108 may include a plurality of X-ray detecting devices. Each of the plurality of X-ray detecting devices may establish one channel but embodiments are not limited thereto.

The X-ray detector 108 may detect the X-ray that is generated by the X-ray generating unit 106 and that is transmitted through the object 10, and may generate an electrical signal corresponding to intensity of the detected X-ray.

The X-ray detector 108 may include an indirect-type X-ray detector for detecting radiation after converting the radiation into light, and a direct-type X-ray detector for detecting radiation after directly converting the radiation into electric charges. The indirect-type X-ray detector may use a scintillator. Also, the direct-type X-ray detector may use a photon counting detector. The DAS 116 may be connected to the X-ray detector 108. Electrical signals generated by the X-ray detector 108 may be collected by wire or wirelessly by the DAS 116. Also, the electrical signals generated by the X-ray detector 108 may be provided to an analog-to-digital converter (not shown) via an amplifier (not shown).

According to a slice thickness or the number of slices, only some of a plurality of pieces of data collected by the X-ray detector 108 may be provided to the image processor 126, or the image processor 126 may select only some of the plurality of pieces of data.

Such a digital signal may be provided to the image processor 126 via the data transmitter 120. The digital signal may be provided to the image processor 126 by wire or wirelessly.

The controller 118 may control an operation of each of the components in the CT system 100. For example, the controller 118 may control operations of the table 105, the rotation driver 110, the collimator 112, the DAS 116, the storage 124, the image processor 126, the input device 128, the display 130, and the communication device 132.

The image processor 126 may receive data acquired by the DAS 116 (e.g., raw data that is data before processing), via the data transmitter 120, and may perform pre-processing.

The pre-processing may include, for example, a process of correcting a sensitivity irregularity between channels and a process of correcting signal loss due to a rapid decrease in signal strength or due to the presence of an X-ray absorbing material such as metal.

Data output from the image processor 126 may be referred to as raw data or projection data. The projection data may be stored in the storage 124 with imaging conditions (e.g., the tube voltage, an imaging angle, etc.) during the acquisition of data.

The projection data may be a group of data values that correspond to the intensity of the X-ray that has passed through the object 10. For convenience of description, a group of a plurality of pieces of projection data that are simultaneously obtained from all channels at the same imaging angle is referred to as a projection data set.

The storage 124 may include at least one storage medium from among a flash memory-type storage medium, a hard disk-type storage medium, a multimedia card micro-type storage medium, card-type memories (e.g., an SD card, an XD memory, and the like), random access memory (RAM), static random access memory (SRAM), read-only memory (ROM), electrically erasable programmable ROM (EEPROM), programmable ROM (PROM), magnetic memory, a magnetic disc, and an optical disc.

The image processor 126 may reconstruct a cross-sectional image of the object 10 by using the acquired projection data set. The cross-sectional image may be a 3D image. In other words, the image processor 126 may reconstruct a 3D image of the object 10 by using a cone beam reconstruction method or the like, based on the acquired projection data set.

The input device 128 may receive an external input with respect to an X-ray tomography imaging condition, an image processing condition, or the like. For example, the X-ray tomography imaging condition may include tube voltages, an energy value setting with respect to a plurality of X-rays, a selection of an imaging protocol, a selection of an image reconstruction method, a setting of a FOV area, the number of slices, a slice thickness, a parameter setting with respect to image post-processing, or the like. Also, the image processing condition may include a resolution of an image, an attenuation coefficient setting for the image, setting for an image combining ratio, or the like.

The input device 128 may include a device for receiving a predetermined input from an external source. For example, the input device 128 may include a microphone, a keyboard, a mouse, a joystick, a touch pad, a touch pen, a voice recognition device, a gesture recognition device, or the like.

The display 130 may display an X-ray image reconstructed by the image processor 126.

Exchanges of data, power, or the like between the aforementioned elements may be performed by using at least one of wired communication, wireless communication, and optical communication. The wireless communication may be accomplished via Wi-Fi, 3G, LTE, Bluetooth, NFC, or other communication methods.

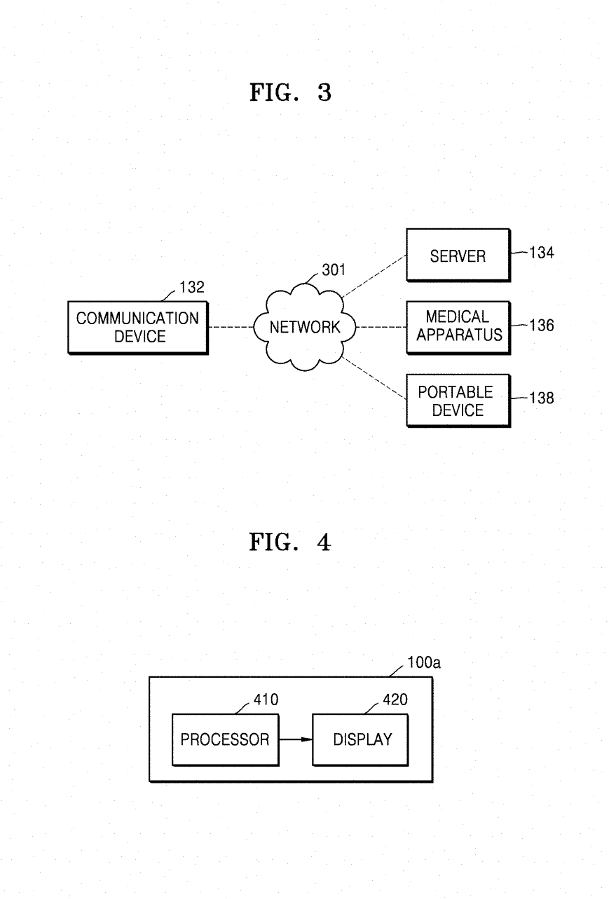

The communication device 132 may perform communication with an external device, an external medical apparatus, etc. via a server 134 or the like. The communication will now be described with reference to FIG. 3.

FIG. 3 is a block diagram illustrating a configuration of the communication device 132.

The communication device 132 may be connected with wires or wirelessly to a network 301 and therefore may perform communication with the server 134, a medical apparatus 136, or a portable device 138. The communication device 132 may exchange data with a hospital server or other medical apparatuses in a hospital connected via a picture archiving and communication system (PACS).

Also, the communication device 132 may perform data communication with the portable device 138 or the like, according to the digital imaging and communications in medicine (DICOM) standard. The portable device may be an electronic device such as a tablet, a smartphone, a cellular telephone, a laptop computer, a smartwatch, a medical terminal, or another type of electronic device.

The communication device 132 may transmit and receive data related to diagnosing the object 10, via the network 301. Also, the communication device 132 may transmit and receive a medical image obtained from the medical apparatus 136 such as a magnetic resonance imaging (MRI) apparatus, an X-ray apparatus, a CT system, or the like.

Furthermore, the communication device 132 may receive a diagnosis history or a medical treatment schedule about a patient from the server 134 and may use the diagnosis history or the medical treatment schedule to diagnose the patient. Also, the communication device 132 may perform data communication not only with the server 134 or the medical apparatus 136 in a hospital but also with the portable device 138 of a user or patient.

Also, the communication device 132 may transmit information about a device error, information about a quality control status, or the like to a system manager or a service manager via the network 301, and may receive a feedback regarding the information from the system manager or service manager.

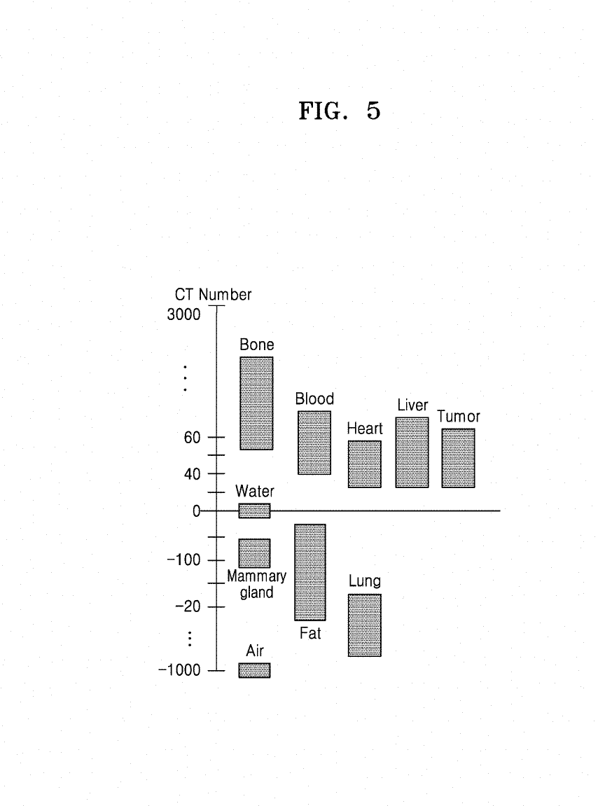

FIG. 4 is a block diagram illustrating a structure of an apparatus 100a for processing a CT image according to an embodiment.

The apparatus 100a according to the present embodiment includes a processor 410 and a display 420. The apparatus 100a including the processor 410 for processing a CT image and the display 420 for displaying the CT image may be implemented as any of various apparatuses. The apparatus 100a may be implemented as, for example, a CT system, a general-purpose computer, a tablet PC, a smartphone, a medical terminal, or a medical image information system. When the apparatus 100a is implemented as the CT system 100 of FIGS. 1 and 2, the processor 410 may correspond to the image processor 126 of FIG. 2 and the display 420 may correspond to the display 130 of FIG. 2. The processor 410 may additionally perform a function of the controller 118 of FIG. 2.

The processor 410 sets window widths and window levels of a plurality of setting areas located on a screen view.

The plurality of setting areas are different areas located on the screen view. Positions and sizes of the plurality of setting areas may be independently determined and may be set so that the plurality of setting areas do not overlap one another. According to an embodiment, the plurality of setting areas may partially overlap one another.

The plurality of setting areas may have shapes defined by, for example, a quadrangle or a closed curve.

Each of the plurality of setting areas has a window width and a window level. The plurality of setting areas may have different window levels. The window levels of the plurality of setting areas may be the same or different.

Also, the processor 410 may generate image data for display from input CT image data. The CT image data may be represented by CT numbers, and the processor 410 may map each of the CT numbers to a brightness value of the image data for display to convert the CT image data into the image data for display. A relationship between the CT numbers and the brightness values of the image data for display may be defined by using a transfer graph or a lookup table. Although the relationship between the CT numbers and the brightness values of the image data for display is defined by using a transfer graph in the specification, embodiments are not limited thereto.

The transfer graph may be differently defined according to the plurality of setting areas. The transfer graph may be defined according to the window widths and the window levels defined for the plurality of setting areas.

Also, the processor 410 generates a screen view showing a CT image on the plurality of setting areas and outputs the screen view to the display 420.

The display 420 displays the screen view showing the CT image on the plurality of setting areas.

The display 420 includes a plurality of pixels and displays image data. The display 420 may be implemented as, for example, a liquid crystal display (LCD) device, an organic electroluminescent device, an electrophoretic display device, or a cathode-ray tube (CRT).

According to an embodiment, the processor 410 may receive information about the number of gray levels and a display grayscale value range of the display 420 from the display 420 or may store previously store the information in a predetermined storage medium.

FIG. 5 is a diagram illustrating CT numbers of body tissue, organs, and materials according to an embodiment.

A variable associated with CT image data may be referred to as a CT number. Body tissue, organs, and materials have their own CT numbers according to components and structures. As such, since body tissue, organs, and materials have their own CT numbers, parts in a CT image may be distinctively displayed and a user may make a diagnosis by checking a state of an object by using the CT image. The CT number may be defined as follows.

$$CT Number = k \times \frac{{μ}_{t} - {μ}_{w}}{{μ}_{w}} . \qquad ( 1 )$$

In this equation, k is a constant value, μₜ is a value for an image area, and μ_{w} is a reference value for water.

Body tissue, organs, and materials may have their own CT numbers as shown in FIG. 5. First, air may have a CT number of about −1000 and water may have a CT number of about 0. The lung and the fat, and the mammary gland which have a relatively high air content may have a low CT number ranging from about −1000 to about 0. Each of a bone, blood, the heart, the liver, and a tumor having a low air content which have a high density may have a CT number ranging from about 0 to about 3000. As such, since body tissue, organs, and materials have CT numbers with different ranges, it is preferable that when a diagnosis is made by using a CT image, CT image data is displayed by setting a window width and a window level corresponding to a range of a CT number corresponding to body tissue, an organ, or a material of interest.

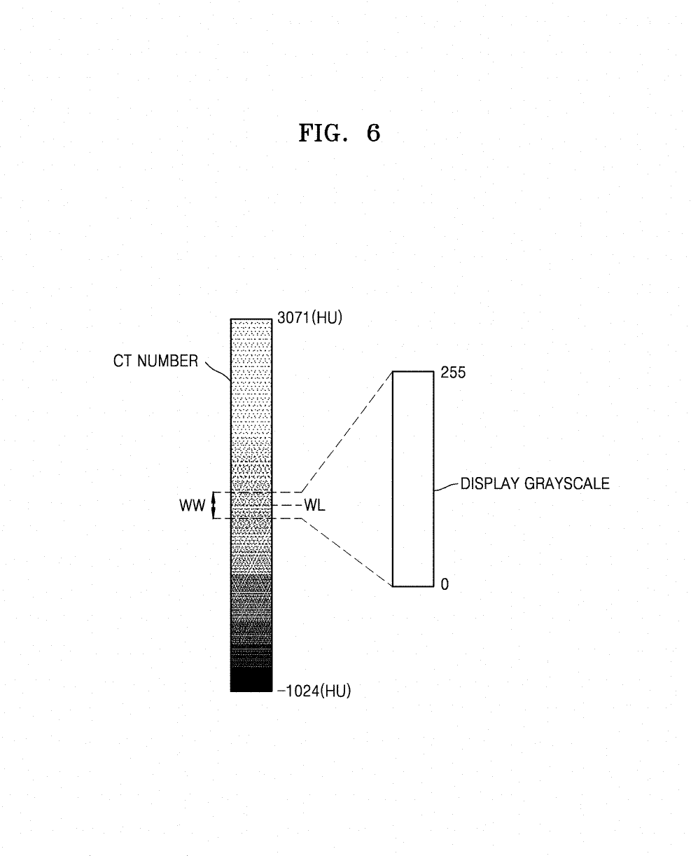

FIG. 6 is a diagram for explaining a CT number and a display grayscale according to an embodiment.

CT image data is represented by CT numbers. For example, 12-bit CT image data may be represented by 4096 CT numbers, and a CT number of each pixel may be determined by an integer ranging from about −1024 to 3071. However, a display grayscale of the display 420 may have grayscale values whose number is less than the range of numbers of the CT numbers of the CT image data. For example, when a CT number is represented as 12 bits and the display 420 is represented as 8 bits and the display 420 displays CT image data, since CT numbers and display grayscale values do not match each other one by one, part of the CT image data may not be displayed in its full detail due to the limited range of the display.

Due to a difference in range between CT numbers and display grayscale values, when CT image data is displayed, a window level and a window width of the CT numbers may be defined. A window level WL that is a representative value of the CT numbers included in a CT number range that may change a display grayscale may be a middle CT number from among the CT numbers included in the CT number range. A value of each CT number may be set according to a linear attenuation coefficient. When the window level WL is low, air or fat having a low radiation absorption coefficient may be shown clearly, and when the window level WL is high, a material such as a bone having a high radiation absorption coefficient may be shown clearly.

For convenience of explanation, a CT number range that may change a display grayscale is referred to as a CT number range of interest. A window width WW indicates the number of CT numbers included in a CT number range that may change a display grayscale. For example, a CT number range of interest may have the window width WW of 700 and the window level WL of 1000.

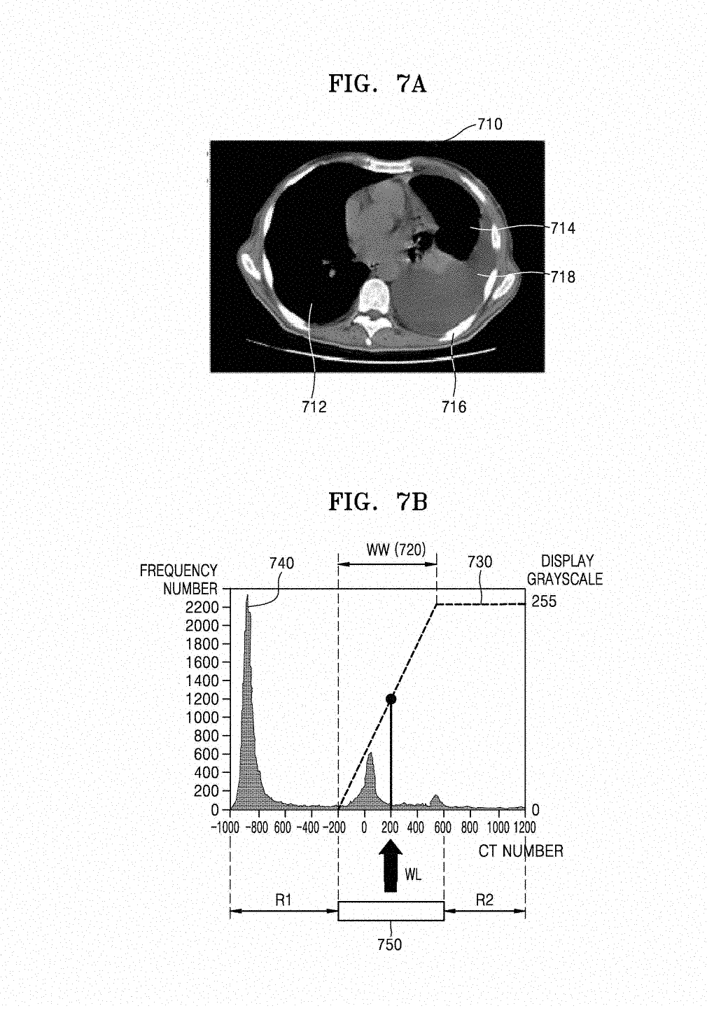

FIGS. 7A and 7B illustrate a display image 710, a transfer graph 730, and a histogram 740 according to an embodiment.

According to an embodiment, a relationship between a CT number and a display grayscale value may be defined by using a transfer graph. For example, as shown in FIG. 7B, in a space where the horizontal axis represents a CT number and the vertical axis represents a display grayscale, the transfer graph 730 showing a relationship between the CT number and the display grayscale may be defined.

As shown in FIG. 7B, when the window width WW and the window level WL of a CT number range of interest 750 are defined, a gradient of the transfer graph 730 in a CT number range included in the CT number range of interest 750 may be set to be greater than that in a CT number range other than the CT number range of interest 750. The processor 410 may adjust a ratio between the number of CT numbers and the number of display grayscale values in a predetermined CT number range by adjusting a gradient of the transfer graph 730. Accordingly, in the CT number range of interest 750, CT numbers of CT image data are distinctively displayed so that different CT numbers correspond to different display grayscale values. However, in the CT number range other than the CT number range of interest 750, the CT numbers of the CT image data may be displayed so that different CT numbers correspond to the same display grayscale value or a display grayscale value difference is less than a CT number difference. Accordingly, image data of the CT number range of interest 750 shows a clear and large CT number difference whereas image data of the CT number range other than the CT number range of interest 750 shows with no or a small CT number difference. As such, a process where a display grayscale value difference is less than a CT number difference is referred to as grayscale compression.

FIG. 7A illustrates the display image 710 in which CT image data is displayed according to the transfer graph 730 of FIG. 7B. The CT image data of FIG. 7A has a CT number distribution like the histogram 740 of FIG. 7B. While most of 8-bit display grayscale values are assigned in the CT number range of interest 750, only a limited number of display grayscale values are assigned in CT number ranges R1 and R2 other than the CT number range of interest 750, thereby leading to grayscale compression. Accordingly, part of the CT image data may be represented by a single grayscale even when there is a CT number difference. For example, although the CT image data of FIG. 7A is determined to have a high frequency number in a CT number range from −1000 to −700 of the histogram 740 as shown in FIG. 7B, CT numbers in the CT number range from −1000 to −700 are all expressed as a minimum display grayscale value of 0 and thus portions corresponding to the CT numbers are displayed as dark portions 712 and 714 in the display image 710. Also, although image data corresponding to the CT number range R2 exists in the histogram 740, CT numbers of the CT number range R2 are all expressed as a maximum display grayscale value of 255 and thus portions corresponding to the CT numbers are displayed white portions 716 and 718 in the display image 710.

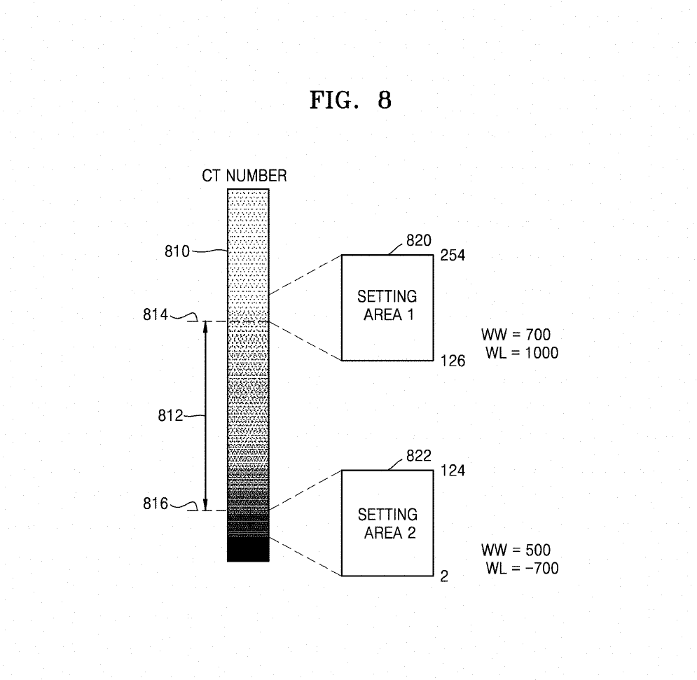

FIG. 8 is a diagram illustrating window widths and window levels of two or more setting areas according to an embodiment.

According to embodiments, a plurality of setting areas may be set on a screen view. The plurality of setting areas may have different window levels. For example, a first setting area 820 and a second setting area 822 may have a predetermined CT number difference 812. For example, a minimum CT number 814 of the first setting area 820 and a maximum CT number 816 of the second setting area 822 may have the predetermined CT number difference 812.

In a CT number range of interest of each of the first and second setting areas 820 and 822, CT numbers may be continuous and display grayscale values may be continuous. For example, a CT number range of interest of the first setting area 820 may correspond to CT numbers ranging from 650 to 1050 and display grayscale values ranging from 126 to 254. A CT number range of interest of the second setting area 822 may correspond to CT numbers ranging from −950 to −450 and display grayscale values ranging from 2 to 124.

Each of the first and second setting areas 820 and 822 has the window width WW and the window level WL. For example, the first setting area 820 may have the window width WW of 700 and the window level WL of 1000, and the second setting area 822 may have the window width WW of 500 and the window level WL of −700.

According to an embodiment, the first setting area 820 may have the window width WW and the window level WL corresponding to a CT number of the lung, and the second setting area 822 may have the window width WW and the window level WL corresponding to a CT number of a bone. The lung has a low CT number of about −700. The bone has a high CT number of about 1000. When the lung and its surroundings are CT-scanned, bone tissue such as a rib or a spine is displayed along with the lung. Accordingly, when the first setting area 820 is set to correspond to a CT number of the lung and the second setting area 822 is set to correspond to a CT number of the bone, the user may check CT image data of the lung and the bone on one screen view. Also, for each of the lung and the bone, a CT number difference in each organ may be identifiably displayed on the one screen view.

According to an embodiment, CT image data may be CT image data obtained through imaging using a contrast agent, and the first setting area 820 may have the window width WW and the window level WL corresponding to a CT number of cancer tissue that absorbs the contrast agent and the second setting area 822 may have the window width WW and the window level WL corresponding to a CT number of soft tissue. The cancer tissue easily absorbs the contrast agent. Accordingly, when the contrast agent is injected into the object and a CT scan is performed, the cancer tissue having absorbed the contrast agent has a very high CT number. In contrast, the soft tissue has a low CT number equal to or less than 0. Accordingly, when the window width WW and the window level WL of the first setting area 820 are set to correspond to the CT number of the cancer tissue having absorbed the contrast agent and the window width WW and the window level WL of the second setting area 822 are set to correspond to the CT number of the soft tissue, the cancer tissue and the soft tissue may be distinctively displayed on one screen. Also, for each of the cancer tissue and the soft tissue, a CT number difference in each organ is displayed on a display image.

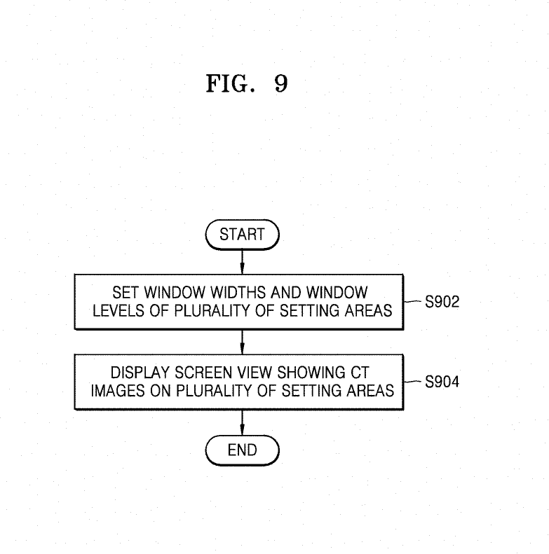

FIG. 9 is a flowchart of a method of processing a CT image according to an embodiment.

Operations of the method may be performed by an electronic apparatus including a processor for processing an image and a display. The following will be explained on the assumption that the apparatus 100a performs the method according to embodiments. Accordingly, the description made for the apparatus 100a may apply to the method of FIG. 9 and the description made for the method of FIG. 9 may apply to the apparatus 100a. Although the following is explained on the assumption that the method is performed by the apparatus 100a, embodiments are not limited thereto and the method may be performed by any of various other electronic apparatuses.

In operation 5902, an apparatus for processing a CT image sets a window width and a window level of each of a plurality of setting areas. The plurality of setting areas have different window levels.

Next, in operation 5904, the apparatus for processing the CT image displays a screen view showing a CT image on the plurality of setting areas. The plurality setting areas may be set as different areas on the screen view and positions, sizes, and shapes of the plurality of setting areas may be determined.

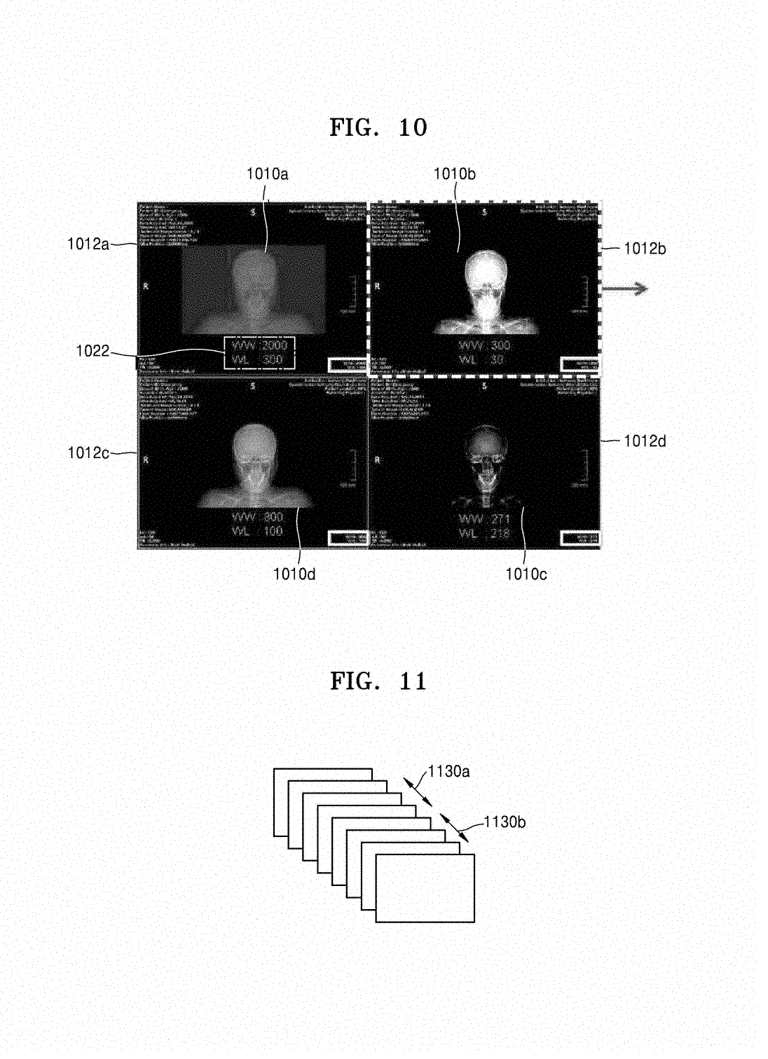

FIG. 10 illustrates a screen view according to an embodiment.

According to an embodiment, a plurality of setting areas may be respectively a plurality of viewing areas, e.g., first through fourth viewing areas 1012a, 1012b, 1012c, and 1012d, as shown in FIG. 10. The same CT image may be displayed as display images 1010a, 1010b, 1010c, and 1010d with different window widths and different window levels on the first through fourth viewing areas 1012a, 1012b, 1012c, and 1012d. For example, as shown in FIG. 10, a CT image of the front of the head of a person may be displayed on the first through fourth viewing areas 1012a, 1012b, 1012c, and 1012d, and the first viewing area 1012a may display the display image 1010a with the window level WL of 300 that is a high window level and the window width WW of 2000 that is a large window width, and the second viewing area 1012b may display the display image 1010b with the window level WL of 30 that is a low window level and the window width WW of 300 that is a small window width. According to the present embodiment, when display images with different window levels are displayed on the first through fourth viewing areas 1012a, 1012b, 1012c, and 1012d, different CT number ranges with different level may be displayed on one screen, thereby improving user convenience. Also, according to the present embodiment, since display images with different window widths are displayed on the first through fourth viewing areas 1012a, 1012b, 1012c, and 1012d, only a desired CT number range may be highlighted or a wide CT number range may be identifiably displayed, thereby improving user convenience.

According to an embodiment, information about the window width WW and the window level WL corresponding to each of the first through fourth viewing areas 1012a, 1012b, 1012c, and 1012d may be displayed on a predetermined area 1022 of each of the first through fourth viewing areas 1012a, 1012b, 1012c, and 1012d.

According to an embodiment, at least one from among a number and an arrangement of the first through fourth viewing areas 1012a, 1012b, 1012c, and 1012d may be set and changed based on an external signal input through an input device or a communication device.

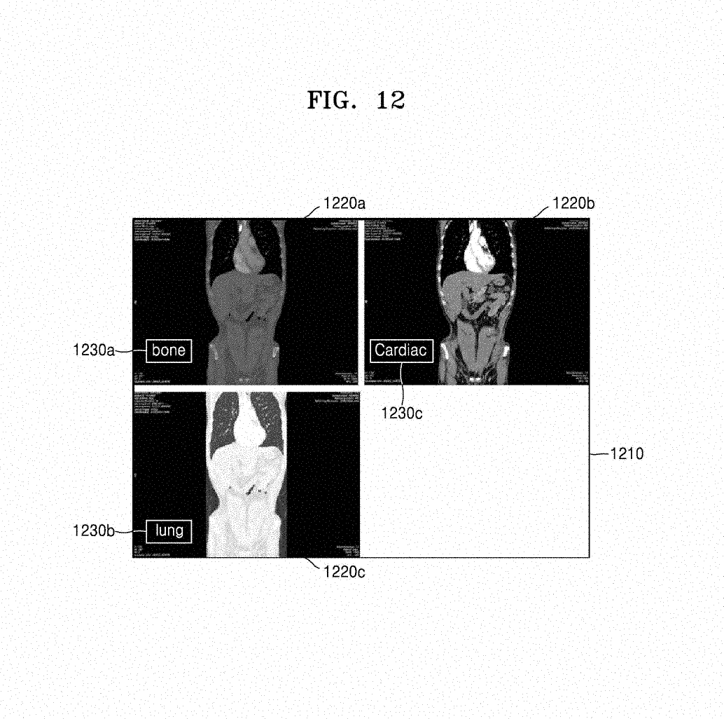

FIG. 11 is a view for explaining an operation of adjusting window widths and window levels of the first through fourth viewing areas 1012a, 1012b, 1012c, and 1012d according to an embodiment.

According to an embodiment, window levels and window widths of a plurality of setting areas may be differently defined according to slice sections of CT image data. For example, window levels and window widths of a plurality of setting areas for a first slice section 1130a may be different from window levels and window widths of a plurality of setting areas for a second slice section 1130b.

According to an embodiment, when a displayed slice section is changed, variables other than a window width and a window level may be the same on two or more viewing areas whereas the window width and the window level may be changed. For example, in an apparatus for processing a CT image according to an embodiment, when a slice section is changed, a rendering method and a zoom factor may not be changed and may be applied to two or more viewing areas. Examples of the rendering method include minimum value rendering, maximum value rendering, and average value rendering.

The apparatus for processing the CT image according to an embodiment may change variables other than a window width and a window level for two or more viewing areas at the same time. For example, for two or more viewing areas, the apparatus for processing the CT image may change one or more from among a zoom factor, a rendering method, a display area, a slice section, and a slice thickness at the same time.

FIG. 12 illustrates a screen view 1210 showing a CT image displayed on a plurality of setting areas according to an embodiment.

According to an embodiment, as shown in FIG. 12, a CT image may be displayed as images with different window widths and window levels on a plurality of viewing areas, e.g., first through third viewing areas 1220a, 1220b, and 1220c. For example, the first viewing area 1220a may have a window width and a window level corresponding to a bone, the second viewing area 1220b may have a window width and a window level corresponding to the heart, and the third viewing area 1220c may have a window width and a window level corresponding to the lung.

According to an embodiment, indicator labels 1230a, 1230b, and 1230c about body parts of an object corresponding to the window widths and the window levels may be respectively displayed on the first through third viewing areas 1220a, 1220b, and 1220c. The indicator labels 1230a, 1230b, and 1230c about the body parts of the object may be displayed as any of various types such as text or figures.

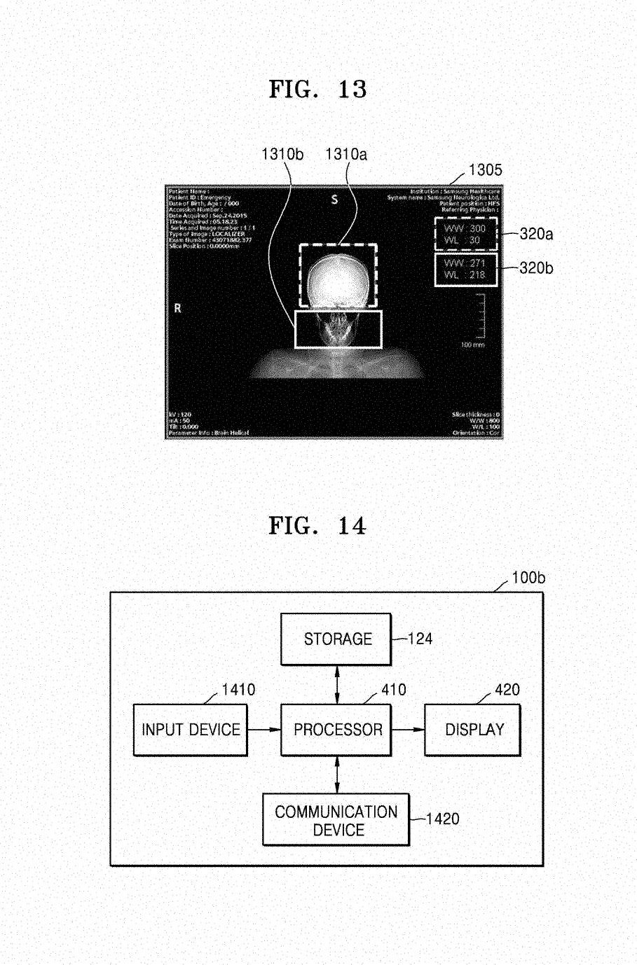

FIG. 13 illustrates a screen view 1305 according to an embodiment.

According to an embodiment, on the screen view 1305 on which one CT image is displayed, a plurality of setting areas, e.g., first and second setting areas 1310a and 1310b, respectively corresponding to some areas of the CT image may be set. The first and second setting areas 1310a and 1310b may have different window levels. Also, each of the first and second setting areas 1310a and 1310 may have a predetermined window width. For example, as shown in FIG. 13, the first setting area 1310a may correspond to the brain, and the second setting area 1310b may correspond to the face. Also, the first setting area 1310a may have the window level WL of 30 and the window width WW of 300 corresponding to the brain, and the second setting area 1310b may have the window level WL of 218 and the window width WW of 271 corresponding to a bone.

According to an embodiment, the screen view 1305 may include information 320a about the window width WW and the window level WL of the first setting area 1310a and information 320b about the window width WW and the window level WL of the second setting area 1310b.

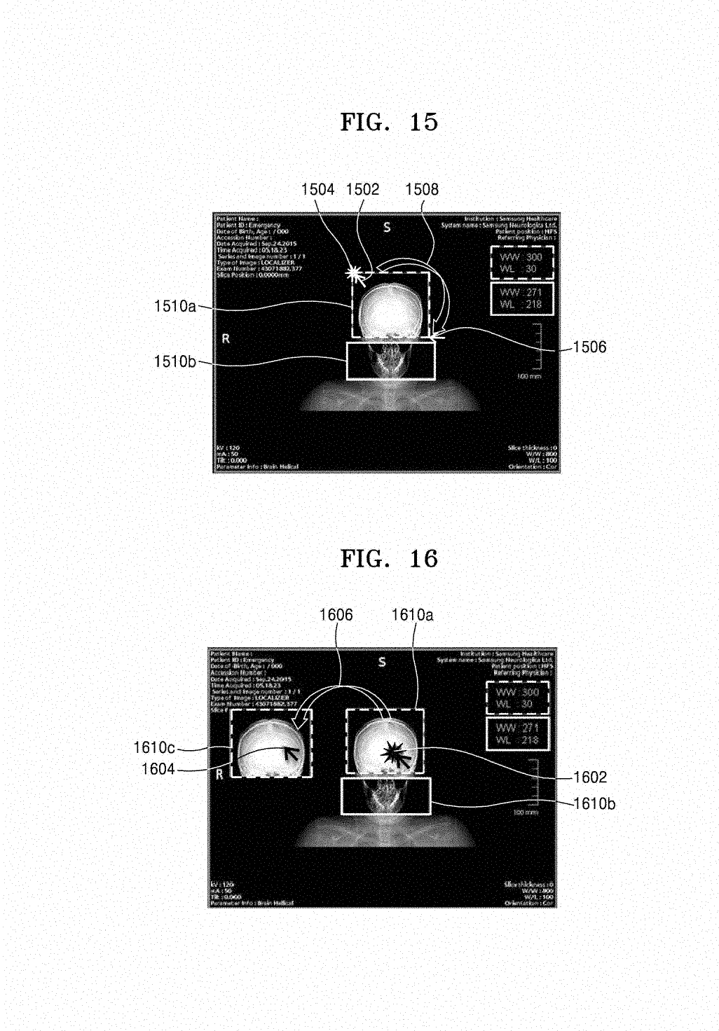

FIG. 14 is a block diagram of an apparatus 100b for processing a CT image according to an embodiment.

The apparatus 100b according to an embodiment includes an input device 1410, the processor 410, the display 420, and a communication device 1420. According to an embodiment, the apparatus 100b may include both the input device 1410 and the communication device 1420, or only one from among the input device 1410 and the communication device 1420. The same description as that made with reference to FIG. 4 will not be given in FIG. 14.

The input device 1410 or the communication device 1420 may receive a control signal. Examples of the control signal may include at least one of a control signal for setting a plurality of setting areas, a control signal for setting a window width, and a control signal for setting a window level.

The input device 1410 receives a control signal. The input device 1410 may include, for example, a keyboard, a button, a touchscreen, a touchpad, a track ball, or a mouse. The input device 1410 may correspond to the input device 128 of FIG. 2. The input device 1410 receives a control signal generated by a user's manipulation.

The communication device 1420 communicates with an external apparatus by wire or wirelessly. The communication device 1420 may receive a control signal or data from the external apparatus and may transmit a control signal or data to the external apparatus. The communication device 1420 may correspond to the communication device 132 of FIGS. 2 and 3.

The processor 410 may generate or change a plurality of setting areas according to a control signal input through the input device 1410 or the communication device 1420. Also, the processor 410 may set or change at least one from among window widths and window levels of a plurality of setting areas according to the input control signal.

The storage 124 stores information about setting areas set by the user and information about a window width and a window level of each of the setting areas. According to an embodiment, the storage 124 may store the information about the setting areas set by the user in a predetermined portion of a CT image file. For example, a space for storing the information about the setting areas and the information about the window width and the window level of each of the setting areas may be defined in a data structure of the CT image file.

FIG. 15 illustrates a state where a setting area is generated according to an embodiment.

According to an embodiment, a setting area may be generated according to a control signal received through the input device 1410 or the communication device 1420. For example, as shown in FIG. 15, a user may set a first setting area 1510a by dragging a cursor 1502 in a direction 1508 from a first point 1504 to a second point 1506. In a state where a second setting area 1510b is already set, the first setting area 1510a is added, and thus two setting areas with independent window widths and window levels are set.

According to an embodiment, after an operation of generating a setting area is performed, a graphical user interface (GUI) for setting a window width and a window level of the generated setting area may be provided.

FIG. 16 illustrates a state where a setting area is generated according to an embodiment.

According to an embodiment, a setting area may be copied and added according to a control signal received through the input device 1410 or the communication device 1420. For example, in a state where a first setting area 1610a is set, a user may click on a point 1602 of the first setting area 1610a and may perform a drag and drop operation in a direction 1606 to a second point 1604 to copy the first setting area 1610a and generate a third setting area 1610c. As a result, the third setting area 1610c is generated in addition to the first setting area 1610a and a second setting area 1610b. A CT image displayed on the first setting area 1610a may also be displayed on the first setting area 1610c generated by performing the drag and drop operation on the first setting area 1610a as shown in FIG. 16. According to an embodiment, after the third setting area 1610c is generated, a GUI for setting a window width and a window level of the third setting area 1610c may be provided. The window width and the window level of the third setting area 1610c may be independently set with respect to the first setting area 1610a.

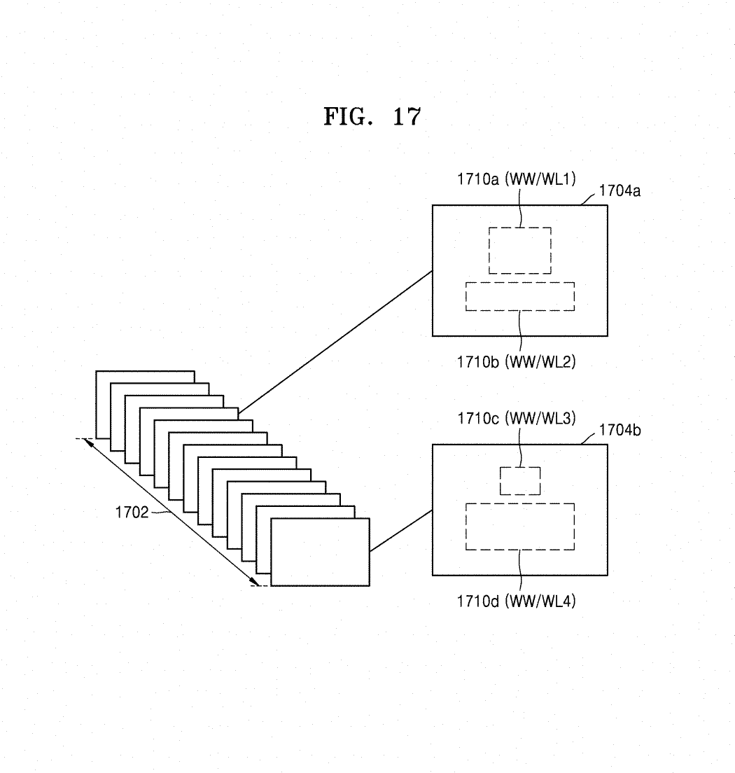

FIG. 17 is a view for illustrating a process of adjusting a plurality of setting areas, a width window, and a window level according to an embodiment.

According to an embodiment, at least one from among positions and sizes of a plurality of setting areas may be changed according to slice sections. Positions and sizes of only some from among the plurality of setting areas may be changed according to slice sections, or positions and sizes of all of the plurality of setting areas may be changed according to slice sections. Also, according to slice sections, only one from among a window width and a window level of a predetermined setting area may be changed or both the window width and the window level may be changed.

According to an embodiment, as shown in FIG. 17, in CT image data 1702, a first setting area 1710a and a second setting area 1710b may be set for a first CT image 1704a corresponding to a first slice section, and a third setting area 1710c and a fourth setting area 1710d may be set for a second CT image 1704b corresponding to a second slice section. Also, the first through fourth setting areas 1710a, 1710b, 1710c, and 1710d may have different window widths and window levels WW/WL1, WW/WL2, WW/WL3, and WW/WL4.

According to another embodiment, only positions and sizes of the first through fourth setting areas 1710a, 1710b, 1710c, and 1710d may be changed according to slice sections and window widths and window levels may not be changed. According to another embodiment, positions and sizes of the first through fourth setting areas 1710a, 1710b, 1710c, and 1710d may not be changed according to slice sections, and only window widths and window levels may be changed.

A slice section may be changed in any of various axis directions. For example, the slice section may be changed in the direction of the x, y, or z-axis.

A plurality of setting area, a window width, and a window level according to slice sections may be previously set by a user or may be automatically set by the processor 410.

According to an embodiment, information about a setting area, a window width, and a window level set for each slice section may be stored along with a data set including a CT image of a plurality of slices.

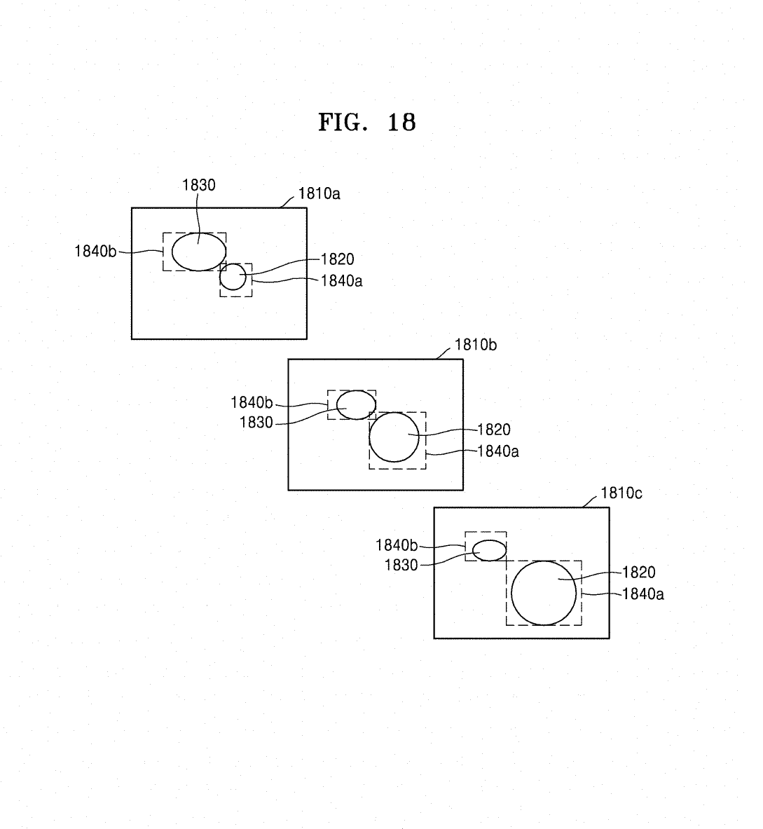

FIG. 18 is a view for illustrating a process of adjusting a plurality of setting areas, a window width, and a window level.

According to an embodiment, when a slice section is changed, positions or sizes of a plurality of setting areas may be changed or a window width or a window level may be changed according to segmentations represented on a CT image. The term ‘segment’ refers to a part or organ of an object such as the liver, the stomach, the heart, or a bone. A case where a first CT image 1810a, a second CT image 1810b, and a third CT image 1810c are displayed as a slice section is changed will now be explained with reference to FIG. 18. As a slice section is changed, positions, shapes, and sizes of a first segment 1820 and a second segment 1830 may be changed as shown in FIG. 18. As such, when positions and sizes of the first and second segments 1820 and 1830 are changed as a slice section is changed, positions and sizes of setting areas may also be changed according to the changed positions and sizes of the first and second segments 1820 and 1830. For example, a first setting area 1840a corresponding to the first segment 1820 may be changed according to slice sections as shown in FIG. 18, and a second setting area 1840b corresponding to the second segment 1830 may be changed according to slice sections as shown in FIG. 18.

According to an embodiment, an apparatus for processing a CT image may recognize a segment corresponding to each setting area from a CT image and may change a position and a size of the setting area according to a change in a position and a size of the segment.

According to another embodiment, the apparatus for processing the CT image may determine a segment for setting a setting area corresponding to the segment according to a control signal input through the input device 1410 or the communication device 1420, may generate the setting area according to a position and a size of the segment, and may adjust a position and a size of the setting area to correspond to the position and the size of the segment according to slice sections.

According to an embodiment, the apparatus for processing the CT image may adjust a window width and a window level of a setting area according to a change in a CT number range of a segment according to a change in a slice section.

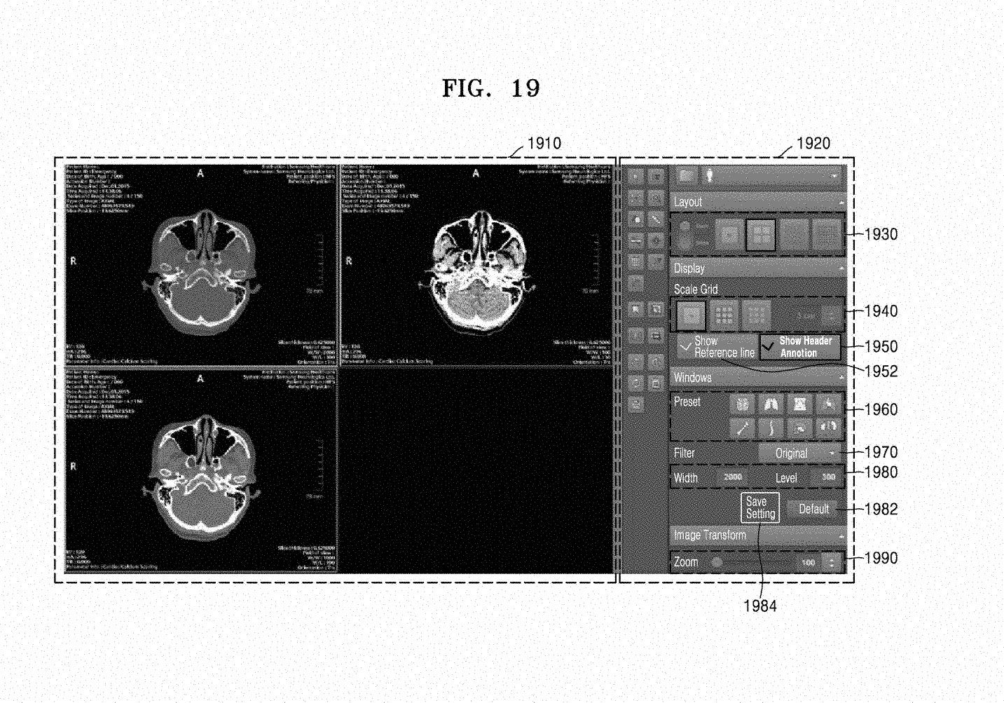

FIG. 19 illustrates a GUI screen view according to an embodiment.

The GUI screen view according to an embodiment has an image display region 1910 and a manipulation region 1920.

A CT image is displayed on a plurality of viewing areas on the image display region 1910. The viewing areas may have different window widths and different window levels. According to another embodiment, the CT image and a plurality of setting areas may be displayed on the image display region 1910 as described with reference to FIG. 13.

According to an embodiment, the CT image displayed on the image display region 1910 may be a preview image reflecting a setting value changed according to a control signal input through the manipulation region 1920.

The manipulation region 1920 may include a layout selection region 1930, a scale grid selection region 1940, a segment selection region 1960, a filter selection region 1970, a window width and window level setting region 1980, and a zoom factor setting region 1990. The manipulation region 1920 may be implemented by combining the above regions in various ways. That is, the GUI screen view having any of various combinations including all or some of the regions of FIG. 19 may be generated.

The layout selection region 1930 may receive a control signal for selecting the number and an arrangement of viewing areas. The scale grid selection region 1940 may receive a control signal for selecting whether to display a scale grid or a control signal for selecting an interval or of a shape of the scale grid.

The segmentation selection region 1960 may receive a control signal for selecting a segment. The segment selection region 1960 may include a selection key corresponding to each segment including description of the segment or organ as a picture or text. An apparatus for processing a CT image may set a window width and a window level by using a value corresponding to the segment selected by the segment selection region 1960.

The filter selection region 1970 may receive a control signal for selecting a filter to be applied to at least one viewing area of the image display region 1910. Once the filter is selected, the apparatus for processing the CT image performs filtering on a CT image to be displayed on the viewing area and displays the filtered CT image on the viewing area.

The window width and window level setting region 1980 may receive a control signal for setting a window width and a window level of a selected setting area.

The zoom factor setting region 1990 may receive a control signal for setting a zoom factor. According to the control signal for setting the zoom factor, the apparatus for processing the CT image may change a zoom factor of a CT image displayed on the image display region 1910. For example, the CT image on the image display region 1910 may be displayed by being enlarged or reduced according to the zoom factor.

When a key 1952 is selected, the apparatus for processing the CT image receives a control signal for selecting whether to display a reference line. The apparatus for processing the CT image may display or may not display the reference line on the CT image display region 1910 according to the control signal for selecting whether to display the reference line.

A key 1950 may receive a control signal for selecting whether to display a header comment. CT image data may include comment information in a header portion. The apparatus for processing the CT image may display or may not display the comment information included in the header portion along with a CT image according to the control signal for selecting whether to display the comment information.

When a key 1982 is selected, the apparatus for processing the CT image receives a control signal for setting certain setting values of the manipulation region 1920 as default values. The default values may be previously stored.

When a key 1984 is selected, information about a setting area set for each CT image and information about a window width and a window level are stored. The information about the set setting area and the information about the window width and the window level may be stored in a CT image file or may be stored in a separate file. Also, when the key 1984 is selected, a screen layout that is currently set may be stored along with a CT image. For example, when a user designates a screen layout to a data set of a CT image, the screen layout may be stored along with the data set of the CT image.

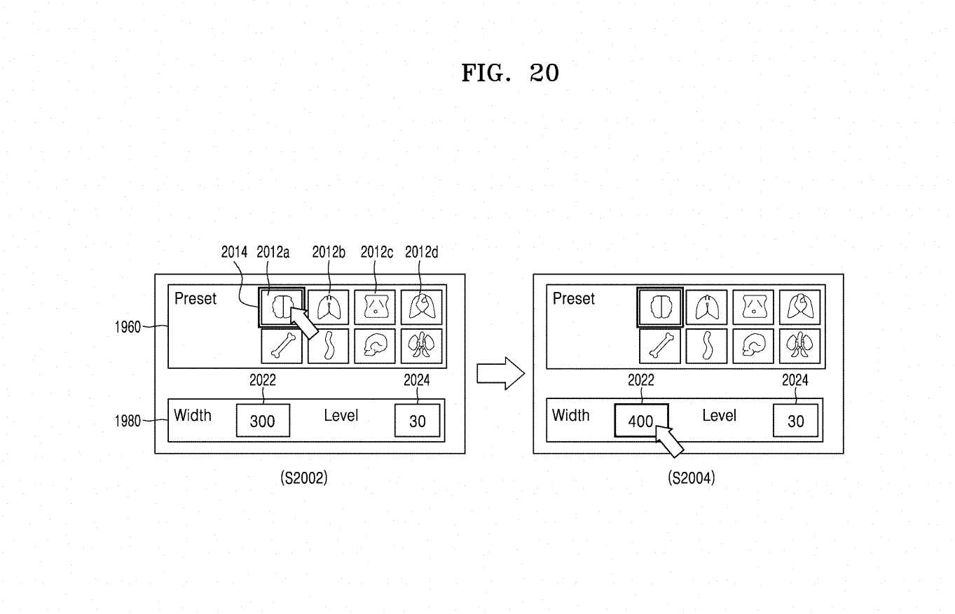

FIG. 20 illustrates a GUI screen according to an embodiment.

According to an embodiment, the segment selection region 1960 and the window width and window level setting region 1980 may be displayed on the GUI screen, and the processor 410 (see FIG. 4) may set a window width and a window level by using a user input received through the segment selection region 1960 and the window width and window level setting region 1980. An arrangement, a configuration, and types of segment icons 2012a, 2012b, 2012c, and 2012d of the GUI screen may vary according to embodiments.

The segment selection region 1960 is a GUI region for selecting a body part or tissue and setting a window width and a window level. The segment selection region 1960 includes one or more icons 2012a, 2012b, 2012c, and 2012d indicating body parts, organs, or certain types of tissue. When one from among the icons 2012a, 2012b, 2012c, and 2012d shown on the segment selection region 1960 is selected, a CT number range corresponding to a CT number corresponding to a body part or tissue of the selected icon 2012a may be set as a window with and window level value in operation S2002. For example, when the icons 2012a, 2012b, 2012c, and 2012d respectively indicating the brain, the lung, the abdomen, the kidney, and a bone are displayed on the segment selection region 1960 and the icon 2012a corresponding to the brain of a user is selected, a CT number range (e.g., from −120 to 180) corresponding to the brain is set as a window width and window level value. A setting value set by an input through the segment selection region 1960 may be displayed on the window width and window level setting region 1980. The selected icon 2012a may be displayed differently from the other icons 2012b, 2012c, and 2012d by using a box 2014 or the like.

A window width and window level value selected and set by the segment selection region 1960 may be adjusted by using an input through the window width and window level setting region 1980 in operation S2004. For example, in a state where the icon 2012a corresponding to the brain is selected on the segment selection region 1960 and a window width of 300 and a window level of 30 are set on the window width and window level setting region 1980, when a window width display portion 2022 is selected by an input signal received through the input device 1410 (see FIG. 14) and a setting value for a window width is input, a window width may be changed according to the input setting value. Likewise, a window level display portion 2024 is selected by an input signal received through the input device 1410 and a setting value for a window level is input, a window level may be changed according to the input setting value.

According to the present embodiment, the user may roughly set a window width and a window level on the segment selection region 1960, and may directly set a window width and a window level on the window width and window level setting region 1980. Accordingly, the user may easily set a window width and a window level of a segment of interest and may precisely adjust a preset value, thereby improving user convenience.

Embodiments may be implemented as software programs including instructions stored in computer-readable storage media.

A computer that is an apparatus for fetching instructions stored in a storage medium and performing an operation according to the fetched instructions may include a CT system according to embodiments.

A computer-readable storage medium may be provided as a non-transitory storage medium. When a storage medium is ‘non-transitory’, it means that the storage medium does not include a signal and is tangible, and it does not limit that data is semi-permanently or temporarily stored in the storage medium.

Also, a CT system or method according to embodiments may be included in a computer program product and may be provided. The computer program product may be exchanged between a seller and a buyer.

The computer program product may include a software program and a computer-readable storage medium storing a software program. For example, the computer program product may include a product (e.g., a downloadable application) that is electronically distributed as a software program through an electronic market (e.g., Google Play Store or AppStore) or a manufacturer of a CT system. For electronic distribution, at least a part of the software program may be stored in a storage medium or may be temporarily generated. In this case, the storage medium may be a server of the manufacturer, a server of the electronic market, or a storage medium of a relay server that temporarily stores the software program.

The computer program product may include a storage medium of a server or a storage medium of a terminal (e.g., a CT system) in a system including the server and the terminal. Alternatively, when a third apparatus (e.g., a smartphone) communicating with the server or the terminal exists, the computer program product may include a storage medium of the third apparatus. Alternatively, the computer program product may include a software program itself transmitted from the server to the terminal or the third terminal or from the third apparatus to the terminal.

In this case, one from among the server, the terminal, and the third apparatus may execute the computer program product and may perform the method according to embodiments. Alternatively, two or more from among the server, the terminal, and the third apparatus may execute the computer program product and may execute the method according to embodiments.

For example, the server (e.g., a cloud server or an artificial intelligence (AI) server) may execute the computer program product stored in the server and may control the terminal communicating with the server to perform the method according to embodiments.

Alternatively, the third apparatus may execute the computer program product and may control the terminal communicating with the third apparatus to perform the method according to embodiments. For example, the third apparatus may remotely control a CT system to emit an X ray to an object and form an image of a body part of the object based on information about radiation passing through the object and detected by an X ray detector.

Alternatively, the third apparatus may execute the computer program product and may directly perform the method according to embodiments based on a value input from an auxiliary device (e.g., a gantry of a CT system). For example, the auxiliary device may emit an X ray to an object and may obtain information about radiation passing through the object and detected. The third apparatus may receive the information about the radiation from the auxiliary device and may form an image of a body part of the object based on the input information about the radiation.

When the third apparatus executes the computer program product, the third apparatus may download the computer program product from the server and may execute the downloaded computer program product. Alternatively, the third apparatus may execute the computer program product that is preloaded and may perform the method according to embodiments.

According to embodiments, when a CT image is displayed, two or more parts of an object with different CT number ranges may be simultaneously checked.

Also, according to embodiments, when a CT image is displayed, a widow width and a window level may be easily adjusted while a slice section is changed.

While the present disclosure has been particularly shown and described with reference to embodiments thereof, the embodiments have merely been used to explain the present disclosure and should not be construed as limiting the scope of the present disclosure as defined by the claims. The embodiments should be considered in a descriptive sense only and not for purposes of limitation.

What is claimed is:

1. An apparatus for processing a computed tomography (CT) image, the apparatus comprising:
a display configured to display a screen view showing a plurality of CT images respectively corresponding to a plurality of setting areas; and
a processor configured to:
set window widths that indicate a number of CT numbers included in a CT number range that may change a display grayscale and window levels that are representative values of the CT numbers included in the CT number range, of the plurality of setting areas of the display and
generate and convert the plurality of CT images according to the window widths and the window levels respectively corresponding to the plurality of setting areas,
wherein the window levels of the plurality of setting areas are different, and
the plurality of CT images correspond to a same slice of a same data set.

2. The apparatus of claim 1, wherein each of the plurality of setting areas corresponds to a corresponding viewing area of the display.

3. The apparatus of claim 2, further comprising an input device configured to generate a control signal for controlling the screen view,
wherein the processor is further configured to change at least one from among a rendering method, a zooming setting value, and slice sections, for the plurality of setting areas, based on the control signal.

4. The apparatus of claim 1, wherein the plurality of setting areas correspond to different areas on the display defined in one CT image.

5. The apparatus of claim 4, further comprising an input device configured to generate a control signal for setting the plurality of setting areas,
wherein the processor is further configured to perform at least one from among a process of adding an additional setting area, a process of deleting a setting area of the plurality of setting areas or the additional setting area, a process of changing the setting area or the additional setting area, a process of changing a window width of the setting area or the additional setting area, and a process of changing a window level of the setting area or the additional setting area, based on the control signal.

6. The apparatus of claim 5, further comprising a storage configured to store information about the plurality of setting areas, the window widths, and the window levels set according to the control signal.

7. The apparatus of claim 4, further comprising an input device configured to generate a control signal for setting the plurality of setting areas,
wherein the processor is further configured to generate, on the screen view, an additional setting area displaying CT image data that is same as CT image data displayed on a setting area selected by the control signal, from among the plurality of setting areas.

8. The apparatus of claim 4, wherein window widths and window levels of the plurality of setting areas are differently defined according to slice sections of the CT image.

9. The apparatus of claim 4, wherein positions and sizes of the plurality of setting areas are differently defined according to slice sections of CT image data.

10. The apparatus of claim 4, wherein at least one from among positions, sizes, window widths, and window levels of the plurality of setting areas are differently defined according to segments of an object displayed on CT image data.

11. A method of processing a computed tomography (CT) image, the method comprising:
setting window widths that indicate a number of CT numbers included in a CT number range that may change a display grayscale and window levels that are representative values of the CT numbers included in the CT number range, for a plurality of setting areas of a display;
generating and converting a plurality of CT images according to the window widths and the window levels corresponding to the plurality of setting areas; and
displaying a screen view showing the plurality of CT images respectively corresponding to the plurality of setting areas,
wherein the plurality of setting areas have different window levels,
wherein the plurality of CT images correspond to a same slice of a same data set.

12. The method of claim 11, wherein each of the plurality of setting areas corresponds to a corresponding viewing area of the display.

13. The method of claim 12, further comprising:
receiving a control signal for controlling the screen view; and
changing at least one from among a rendering method, a zooming setting value, and slice sections of the plurality of setting areas, based on the control signal.

14. The method of claim 11, wherein the plurality of setting areas correspond to different areas on the display defined in one CT image.

15. The method of claim 14, further comprising:
receiving a control signal for setting the plurality of setting areas; and
performing at least one from among a process of adding an additional setting area, a process of deleting a setting area of the plurality of setting areas or the additional setting area, a process of changing the setting area or the additional setting area, a process of changing a window width of the setting area or the additional setting area, and a process of changing a window level of the setting area or the additional setting area.

16. The method of claim 15, further comprising storing information about the plurality of setting areas, the window widths, and the window levels set according to the control signal.

17. The method of claim 14, further comprising:
receiving a control signal for setting the plurality of setting areas; and
generating, on the screen view, an additional setting area displaying CT image data that is same as CT image data displayed on a setting area selected by the control signal, from among the plurality of setting areas.

18. The method of claim 14, wherein window widths and window levels of the plurality of setting areas are differently defined according to slice sections of the CT image.

19. The method of claim 14, wherein positions and sizes of the plurality of setting areas are differently defined according to slice sections of CT image data.

20. A computer program product comprising a non-transitory computer-readable storage medium, the computer-readable storage medium comprising instructions for:
setting window widths that indicate a number of CT numbers included in a CT number range that may change a display grayscale and window levels that are representative values of the CT numbers included in the CT number range, for a plurality of setting areas of a display;
generating and converting a plurality of computed tomography (CT) images according to the window widths and the window levels corresponding to the plurality of setting areas; and
displaying a screen view showing the plurality of CT images respectively corresponding to the plurality of setting areas,
wherein the plurality of setting areas have different window levels,
wherein the plurality of CT images correspond to a same slice of a same data set.
